(19) United States
(12) Patent Application Publication
(10) Pub. No.: US 2017/0352013 A1
(43) Pub. Date: Dec. 7, 2017

(54) Systems and Methods for Managing Rules Associated With Transaction Settlement Procedures

(71) Applicant: MASTERCARD INTERNATIONAL INCORPORATED, Purchase, NY (US)

(72) Inventors: Olga Nogin, St. Louis, MO (US); Navaneethan Sabanathan, Ballwin, MO (US); Fei Wang, Chesterfield, MO (US); Anne E. Henke, Dardenne Prairie, MO (US); Lakshmi Turimella, Lake St. Louis, MO (US); Stephen S. Raja, St. Charles, MO (US)

(21) Appl. No.: 15/170,382

(22) Filed: Jun. 1, 2016

(51) Int. Cl. G06Q 20/10

(52) U.S. Cl. CPC G06Q 20/10

(57) ABSTRACT

Systems and methods are provided for creating and updating settlement rules for determining behavior of a payment network during settlement transactions. One exemplary method includes receiving a request related to creating a settlement rule and/or modifying a settlement rule. The exemplary method also includes causing, by a computing device, an interface, associated with a settlement form, to be displayed to a user. The exemplary method further includes receiving a first response to a first inquiry of the settlement form from the user, altering one of the interface and/or a subsequent interface of the settlement form to include a second inquiry, based on the first response, and causing the altered one of the interface and/or the subsequent interface to be displayed to the user, whereby one or more subsequent inquiries in the settlement form are consistent with prior responses.

### FIELD

The present disclosure generally relates to systems and methods for managing settlement rules associated with transaction settlement procedures in payment networks, wherein the settlement rules, based on parameters associated with issuers and/or acquirers, define interaction procedures for the payment network during settlement of transactions.

### BACKGROUND

This section provides background information related to the present disclosure which is not necessarily prior art.

Payment account transactions are employed ubiquitously in commerce, whereby consumers purchase products (e.g., goods and/or services), through use of payment accounts. Those parties involved in the payment account transactions employ authorization and settlement procedures to ensure sufficient funds and/or credit are available to satisfy the transactions, and then coordinate the movement of funds between the involved parties. Settlement procedures are followed by and between acquirers, payment networks, and issuers to finalize payment account transactions through debiting funds and delivering funds to the appropriate ones of the acquirers and issuers. Each acquirer and/or issuer, interacting with a payment network during settlement procedures, defines rules based on issuer and/or acquirer information and preferences. Payment networks further maintain certain rules for acquirers and/or issuers that dictate the procedures followed. The rules are generally created by the payment network through complex and extensive static forms, which are completed, in total, by the acquirers and/or issuers, for each change to information or preference(s). The forms are, in turn, manually entered into a settlement rules data structure maintained by the payment network.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in creating and updating settlement rules;

FIG. 2 is a block diagram of a computing device that may be used in the exemplary system of FIG. 1;

FIG. 3 is a flowchart describing an exemplary method, that may be implemented in connection with the system of FIG. 1, for creating a settlement rule using the rules engine of the present disclosure;

FIGS. 4-10 are exemplary interfaces, including portions of a dynamic net settlement information form (NSIF), and which may be displayed to a user on a computing device in connection with the system of FIG. 1 and/or the method of FIG. 3, for providing parameters of settlement rules; and

FIGS. 11 and 12 are exemplary interfaces including further portions of the dynamic NSIF, which may be displayed to a user on a computing device in connection with the system of FIG. 1 and/or the method of FIG. 3, for providing relationships between an advisement type and a media type.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Settlement of payment account transactions is subject to multiple procedures, which are defined by rules, and which may in turn be based on information and/or preferences (broadly, parameters) solicited from and provided by the issuers and/or acquirers involved in the transactions. The parameters vary between different issuers and acquirers depending on, for example, the extent of their involvement in payment account transactions, their locations, currencies involved, use of agents, etc. Uniquely, the systems and methods herein are capable of managing intake of parameters from the issuers and/or acquirers through the use of derived data collection. In particular, a settlement rules engine interacts with issuers and/or acquirers to solicit necessary parameters, by presenting and/or modifying a dynamic electronic form, based on business rules and/or parameters previously supplied by the issuers and/or acquirers. In this manner, the managing of such parameters is driven by the issuers and/or acquirers, specific to settlement profiles of the issuers and/or acquirers (including the provided parameters). The settlement rules engine is then able to coordinate with an in-use settlement data structure to integrate and/or employ certain rules included therein, which may be defined by the issuers' and/or acquirers' parameters (i.e., received via the electronic form), whereby subsequent settlement procedures are defined, at least in part, by the parameters.

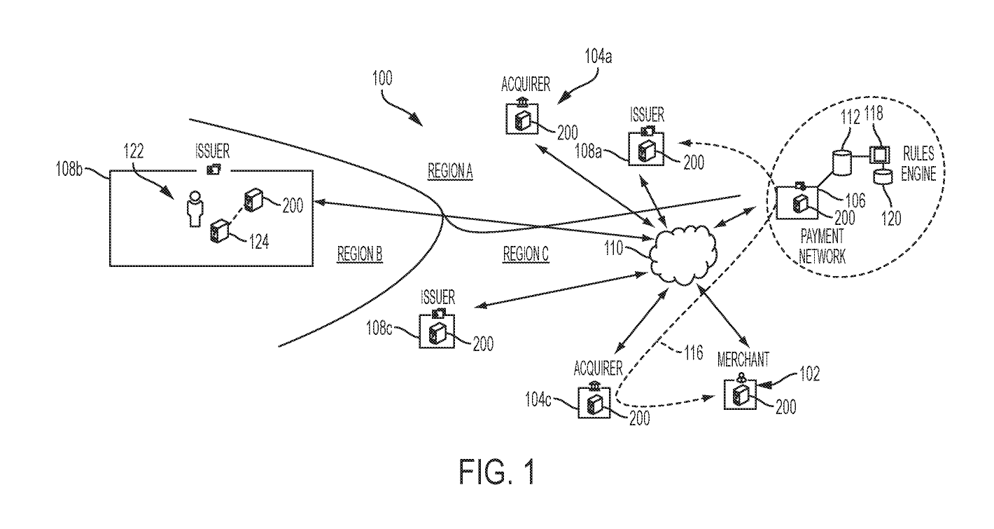

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, regional groupings of parts of the particular system, transactional roles employed in the system, particular parties included in the system and associated with transactions therein, etc.

The system 100 generally includes a merchant 102, acquirers 104a and 104c, a payment network 106, and issuers 108a-c, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirers 104a and 104c and the issuers 108a-c (broadly, banking entities) and, separately, the public Internet, which may provide interconnection between the merchant 102 and the acquirers 104a and 104c, etc.

The system 100 also includes separate regions A, B, and C. The network 110 serves to enable communication between the merchant 102, the acquirers 104a and 104c, the payment network 106, and the issuers 108a-c across the multiple regions A, B, and C. The regions A, B, and C do not limit communication and/or transactions between parts of system 100, but rather serve, for example, as boundaries indicated in any conventional manners (e.g., geographic, organizational, functional, etc.). The boundaries may further play one or more roles in determining behavior of the parts of system 100 during settlement. For instance, issuer 108c in region C (e.g., an English speaking region, etc.) may prefer that advisements be in English (i.e., a parameter defined by the issuer 108c), while the acquirer 104a in region A may prefer that advisements be in Spanish or some other language. Regional differences may also affect other aspects of settlement, by business rules of the payment network 106 and/or by parameters of the issuers 108a-c and/or acquirers 104a and 104c, such as currency, input sources, licensing restrictions, countries, transfer agents, agent settings, and/or other parameters (as discussed more below).

It should be appreciated that the regions A, B, and C may be any different type of geographical, organizational, or functional division of parts of the system 100 (or other parts not shown). In particular, regions as used herein may be defined by area codes, postal codes, states, territories, countries, continents, etc. Alternatively (or additionally), regions may be defined by other logical or organizational divisions as well, such as separate divisions or business units of a company, separate agencies in a governmental entity, or the like (whereby such regions may even overlap in geography). Different regions may suggest that different parameters will be provided by particular issuers and/or acquirers, or not.

Generally in the system 100, a consumer (not shown) completes purchase transactions for products with the merchant 102 (or with other merchants) using a payment account associated with the consumer. Specifically, the consumer, from region A in this example, initiates a transaction by presenting a payment device to the merchant 102 in region C, for example. The merchant 102, in turn, reads the payment device and/or otherwise receives payment account information from the consumer, and then communicates an authorization request to the acquirer 104c (i.e., the acquirer associated with the merchant 102 in region C), as shown in FIG. 1, by reference to path 116. The acquirer 104c, in turn, communicates the authorization request through the payment network 106 (e.g., through MasterCard®, VISA®, Discover®, American Express®, etc.) to the issuer 108a (i.e., the issuer associated with the payment account of the consumer in this example). The issuer 108a then sends a reply (i.e., authorizing or declining the transaction) back to the merchant 102, along the path 116, which permits the merchant 102 to conclude or end the transaction.

If the transaction is authorized (and concluded by the merchant 102), the transaction is later settled by and between the parts of system 100, generally in combination with multiple other transactions involving the acquirer 104c and/or issuer 108a. In particular, the merchant 102 sends its payment account transactions in a batch file to the acquirer 104c, for example, at the end of the day, or within a predefined interval. The batch file includes pertinent information for each transaction to the merchant 102, including, for example, an account number, an amount of the transaction, a merchant ID, etc. In turn, the acquirer 104c reconciles the sent transactions and sends them on to the payment network 106 (i.e., to a clearing aspect of the payment network 106), etc. The payment network 106 then settles the transactions by debiting funds from appropriate accounts at the issuer 108a (as defined by clearing records received from the acquirer 104c) and crediting the funds to accounts associated with the acquirer 104c for the net amount of the transactions, less any interchange and/or network fees charged by the payment network 106. Finally, the issuer 108a records the transactions against the accounts issued to its customers (including the customer in the above example), and the acquirer 104c credits the merchant's account. This also applies to transactions involving the acquirer 104a and issuers 108b-c.

As part of the above, the payment network 106 abides by established settlement procedures defined by settlement data structure 112, as it interacts with the issuer 108a and/or the acquirer 104c to process the batch file. The procedures are based on settlement rules, which are, in turn, based on business rules of the payment network 106 and/or parameters provided by the issuer 108a and/or the acquirer 104c (e.g. preferred currency, preferred language, preferences for communication methods/media, etc.). Furthermore, the acquirer 104c (and the acquirer 104a) and the issuer 108a (and the issuers 108b-c) are parties to agreements which further govern settlement procedures and/or rules with the payment network 106.

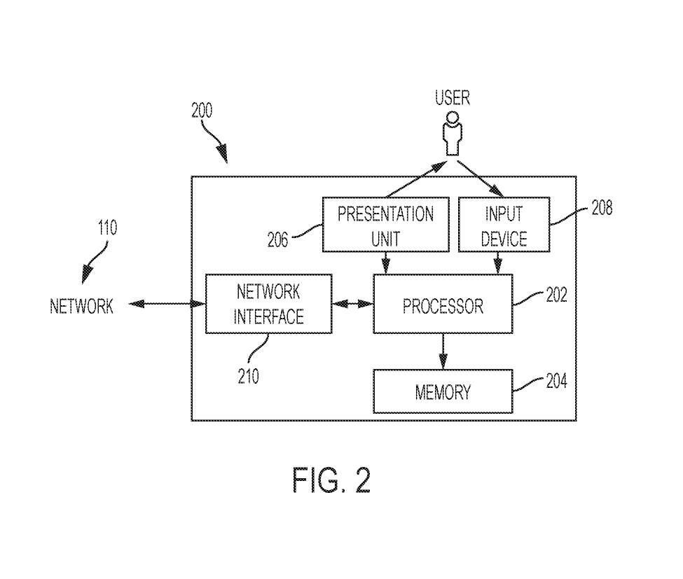

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, and configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirers 104a and 104c, the payment network 106, and the issuers 108a-c are illustrated as including, or being implemented in, computing device 200, coupled to the network 110. Further, the computing devices 200 associated with these parts, for example, again may include a single computing device, or multiple computing devices located in close proximity or distributed over a geographic region, and configured to function as described herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured, as one or more data structures, to store, without limitation, issuer settlement profiles (e.g., biographical data, issuer preferences, etc.), acquirer settlement profiles (e.g., biographical data, acquirer preferences, etc.), transaction data, batch files, business rules, settlement procedures, internet-based interfaces (e.g., as defined by internet-based applications, websites, etc.), and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., settlement parameter interfaces, etc.), visually, for example, to a user of the computing device 200, such as user 122 associated with issuer 108b in the system 100, etc. It should be further appreciated that various interfaces (e.g., as defined by internet-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of certain settlement parameters (e.g., currencies, advisement media, address, licensing, country of operation, etc.), etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, etc. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the payment network 106 includes a rules engine 118 specifically configured, by executable instructions, to manage parameters received from the issuers 108a-c and/or the acquirers 104a and 104c. The payment network 106 also includes a working data structure 120 that is configured to store business rules associated with the payment network 106, as well as the parameters received by the rules engine 118 from the issuers 108a-c and/or the acquirers 104a and 104c and settlement rules queued to be loaded to the settlement data structure 112 (i.e., settlement rules generated by the rules engine 118), etc.

While the rules engine 118, the settlement data structure 112, and the working data structure 120 are illustrated as separate, standalone entities from the payment network 106, it should be understood from the dotted circle in FIG. 1 that the settlement data structure 112, the rules engine 118, and the working data structure 120 may be included together in the payment network 106. In addition, as shown, the rules engine 118 is separate from, yet interacts with and/or is in communication with the settlement data structure 112 (which stores settlement data and, in particular, settlement profiles for each of the acquirers 104a and 104c and the issuers 108a-c employed in settlement as described above). This segregation, however, is not required in all embodiments. Further, in one or more embodiments, the working data structure 120 may be omitted, whereby the rules engine 118 interacts directly with the settlement data structure 112 (via one or more application programming interfaces (APIs), etc.).

The settlement rules and/or parameters, as indicated above, may relate to and/or include a variety of different aspects of the procedures by which transactions are settled by and between the parts of system 100. Such aspects may include, without limitation, currency types (e.g., U.S. dollar, Venezuela's bolivar, etc.), region, country licenses, country or license requirements/restrictions (e.g., based on U.S. embargos, etc.), transaction types (e.g., cross border, domestic, etc.), times at which settlement is executed (i.e., settlement cycles), settlement service criteria, settlement paths (e.g., direct, consolidated, etc.), involved financial institutions and/or agents, input sources, financial institution account numbers and/or formats, transfer agent information (e.g., name, type, location, accounts, etc.), settlement service accounts, delivery channels, advisements (e.g., advisement message types, media, delivery channels, etc.), etc. Apart from, or in combination, a number of business rules (including certain metrics) are defined by the payment network 106, as aspects, to govern the settlement procedures, which may be impacted, or not, by the parameters provided by the issuers 108a-c and/or the acquirers 104a and 104c.

It should be appreciated that any of the above aspects, whether identified as parameters or rules, associated with the issuers 108a-c and/or the acquirers 104a and 104c (or the payment network 106), may be the subject of the operations described herein.

Generally, the rules engine 118 interacts with one or more users associated with the issuers 108a-c and/or the acquirers 104a and 104c in soliciting and/or receiving the parameters as described herein. As shown in FIG. 1, for example, the issuer 108b includes the user 122 (e.g., an employee, manager, administrator, etc.), associated with a workstation computing device 124 (consistent with computing device 200). As the issuer 108b determines that certain parameters are to be added or changed, the user 122 interacts with the rules engine 118, via one or more interfaces (e.g., requests to create/modify parameter(s), etc.). In particular, the rules engine 118 is configured to cause one or more interfaces, which include an electronic form or a net settlement information form (NSIF), to be displayed to the user 122, at the workstation computing device 124. The NSIF is a dynamic form, which is employed to gather parameters from user 122 (or other users) in order to create settlement rules that are consistent with the parameters of the issuer 108b, for example, (and the business rules of the payment network 106).

As the user 122 provides parameters (broadly, responses) to the rules engine 118, via the interface(s), the rules engine 118 is configured to dynamically alter the interface(s) to include content of the NSIF based on responses (broadly, parameters) received from the user 122. Additionally, or alternatively, the dynamic feature of the interface(s) may be defined by the interface(s) itself (by executable instructions), whereby the rules engine 118 may be omitted, at least in part, from altering the interface(s). In either event, because the interface(s) are altered to include content as a result of the user's responses, the interface(s) operate to limit the potential for soliciting unnecessary or unused information and/or for confusing the user 122. In addition, while the interface(s) are described above to solicit parameters from a user, the rules engine 118 may be configured (in certain embodiments) to cause the interface(s) to be displayed in a “read only” mode, whereby the user is able to review, but not edit, the parameters associated with the respective issuers 108a-c and/or acquirers 104a and 104c.

Finally, the rules engine 118 is configured to store rules, created based on business rules and/or parameters, in the working data structure 120. The rules engine 118 is configured to further invoke one or more APIs to load the rules from the data structure 120 to the settlement data structure 112, thereby implementing the rules for use in subsequent settlement procedures (without interrupting the use of the settlement data structure 112). The rules may be created and/or stored in the working data structure 120 for use by the rules engine 118 by direct writes and/or updates to the data structure 120 (and any database tables or the like therein or otherwise). Alternatively, the rules engine 118, the settlement data structure 112, and/or the working data structure 120 may include a front-end interface (e.g., a command line interface, a graphical user interface (GUI), etc.) that enables a user to create and/or update rules stored in the settlement data structure 112 and/or the working data structure 120.

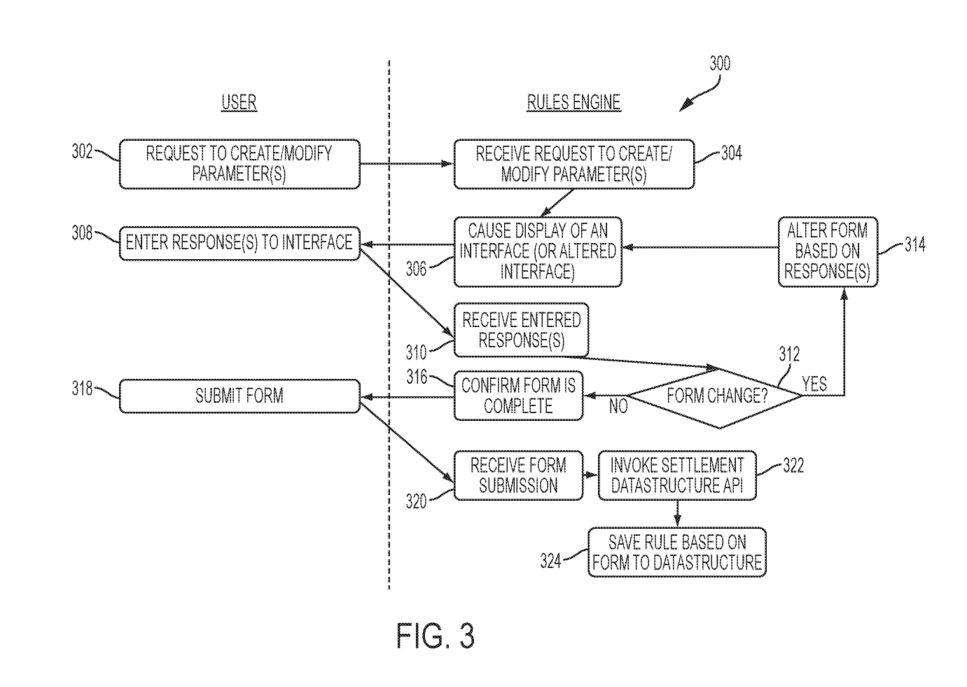

FIG. 3 illustrates an exemplary method 300 for creation of a settlement rule by the user 122, at the issuer 108b, using the rules engine 118 of the payment network 106 in the system 100. The exemplary method 300 is described as implemented in the rules engine 118 of the payment network 106. However, the method 300 is not limited to the rules engine 118, or more generally, the system 100, but may be implemented in other parts of system 100 or in other systems (not shown). Further, while the method 300 is described with reference to issuer 108b (to the exclusion of the other issuers 108a and 108c and the acquirers 104a and 104c illustrated in FIG. 1), for ease of reference, nothing should be understood to limit method 300, or the systems and methods herein, to the issuer 108b, or any aspect of issuer 108b (including the user 122 and the workstation computing device 124). Further still, the exemplary method 300 is described herein with reference to the computing device 200. The methods herein, however, should not be understood to be limited to the exemplary system 100 or the exemplary computing device 200, and likewise, the systems and the computing devices herein should not be understood to be limited to the exemplary method 300.

When the issuer 108b applies to be on-boarded to the payment network 106, or otherwise seeks to change one or more aspects, as described above, the user 122, via workstation computing device 124 (and, thus, the issuer 108b), requests, at 302, to create and/or modify a parameter (or multiple parameters) associated with the issuer 108b. The user's request may be provided, for example, to add a new account, add an agent, modify an existing account, modify an advisement, or add/modify any one or more of the aspects, described above, that may alter and/or affect procedures related to settlement, e.g., settlement rules, etc. In general, the request is provided via one or more internet-based interfaces, for example, an internet-based application, website, etc., for which access is controlled by credentials specific to the issuer 108b and/or the user 122, as is conventionally known.

The rules engine 118, in turn, receives the request to create and/or modify the parameter, at 304, from the user 122, via the one or more internet-based interfaces.

Upon receipt of the request, the rules engine 118 causes, at 306, an interface to be displayed to the user 122 at workstation computing device 124. The interface includes, in this embodiment, at least a portion of a dynamic form, such as, for example, the NSIF described above. The user 122, in turn, provides responses to inquiries included in the interface, at 308, which may be understood herein to be, broadly, parameters. In particular, depending on the particular interface, the user 122 may provide a response in the form of a text entry, a selection from a drop-down menu, a selection of a radio button and/or check box, etc. The rules engine 118 receives the response from the user 122, at 310, and determines, at 312, whether to alter the interface (or a different interface), based on the response received from the user 122 (including either a parameter provided by the user 122 and/or a selection/input to the interface that is not a parameter, i.e., input that is not in response to an inquiry). The determination, at 312, may be based on a structure of the NSIF and/or one or more business rules associated with the payment network 106, which determine what parameters are necessary and/or desired in view of the response(s) from the user 122.

Alternatively, the NSIF may be generated in such a way that it includes logic which dynamically alters the form based on user inputs, without contacting the rules engine 118. That is, the rules engine 118 may embed the enforcement of at least some form alteration rules within the form itself so that the changes occur automatically based on embedded logic within the form (e.g., the rules engine 118 is embedded, at least in part, in the form; etc.).

When the rules engine 118 determines that an alteration is needed or desired, the rules engine 118 alters an interface (e.g., one of the interfaces being displayed and/or a subsequent interface, etc.), at 314, and then causes the altered interface to be displayed to the user 122, at 306. The altered interface may be displayed immediately, or upon selection or advancement to the altered interface by the user 122, etc. This may be repeated multiple times, creating a loop through which the rules engine 118 alters (or does not alter) the interface(s) forming the NSIF, to guide the user 122 to provide complete parameters, as desired or needed, to the payment network 106 in a dynamic and efficient manner. The interface, or interfaces, may be altered, by the rules engine 118, by adding or omitting particular inquiries/pages, by adding or omitting selectable responses (e.g., included in a drop-down menu, etc.) and/or by altering which responses are required or not, etc.

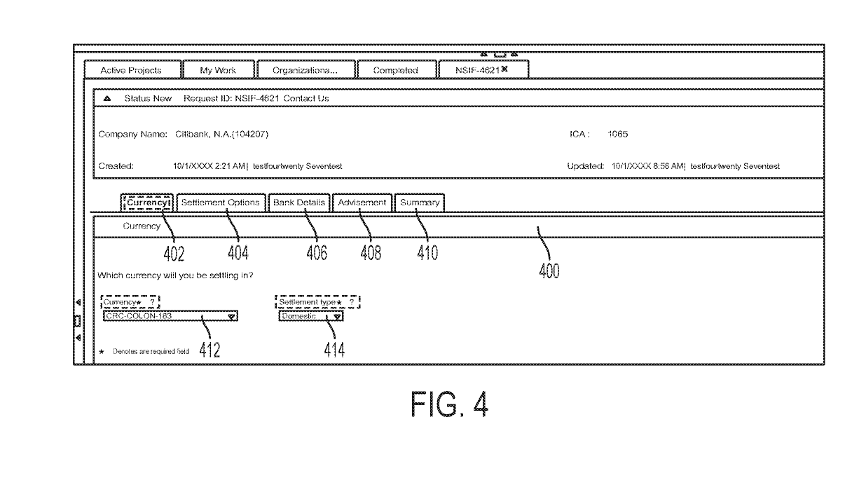

FIGS. 4-9 illustrate exemplary interfaces, which include different parts of an exemplary NSIF (form 400), as well as alterations to the interfaces by the rules engine 118, based on certain business rules and/or responses from the user 122, as described herein. The method 300 will be described in more detail next in connection with the interfaces.

Initially, the form 400 is accessed through a general landing interface (not shown), which is caused to be displayed to the user 122 as part of an internet-based application, website, etc. The landing interface provides the user 122 with the option to select between creating a new settlement rule/parameter, viewing and/or editing a current settlement rule/parameter and/or advisement, copying a current settlement rule/parameter and/or advisement, etc. The landing interface may also provide “pending change” information to inform the user about settlement rules/parameters which have recently had changes made and may require viewing or approval from the user 122. As suggested above, the landing interface is accessible by credentials specific to the issuer 108b and/or the user 122, as is conventionally known.

FIG. 4 illustrates the exemplary form 400 with a currency tab 402 selected. The form 400, as shown in FIG. 4, is caused to be displayed to the user 122 at workstation computing device 124, when the user selects to create a new settlement rule/parameter. It should be appreciated that the exemplary form 400 is substantially consistent, at least in part, with other interfaces that may be displayed to the user 122, for example, when other options (e.g., when other tabs of the form 400 such as the settlement options tab, bank details tab, advisement tab, summary tab, etc.) are selected from the landing interface by the user 122 (or even when other forms are displayed). In such embodiments, when a modification is requested, for example, certain prior responses (broadly, parameters) may be auto-filled and/or pre-filled into the other interfaces or forms, based on responses, during a prior session, from the acquirer, issuer, user, etc.

As shown in FIG. 4, the currency tab 402 enables the user 122 to select parameters which control aspects of the currency used in settlement. The currency tab 402 includes a currency menu 412, which enables the user 122 to select a currency type for use in the settlement, and a settlement type menu 414, which enables the user 122 to select whether the settlement is domestic or a different type, such as a foreign settlement. In response, the rules engine 118 may alter the currency menu 412 in the form 400 to include valid currencies based on business rules and/or settings, which limit and/or define valid currencies for the issuer 108b. And, similarly, the rules engine 118 may alter the form 400, in the settlement type menu 414, to include the list of only valid settlement types (broadly, responses) based on the currency selected and other business rules and/or settings.

Once the user provides the responses in currency tab 402, the user is able to proceed to further tabs in the form 400. Specifically, the form 400 includes multiple additional tabs: a settlement options tab 404, a bank details tab 406, an advisement tab 408, and a summary tab 410. In FIG. 4, these tabs are shown as unselected (or not selectable). As such, these tabs may not be available for viewing yet, for example, based on options available to the user 122, or based on certain responses not being provided yet. For instance, in order for the settlement options tab 404 to be available, a selection of currency and/or settlement type may be required, i.e., the user 122 may need to select a currency at currency menu 412 and/or a settlement type from the settlement type menu 414 on the currency tab 402, in order for the next tab to be selectable. As shown in FIG. 4, the currency menu 412 and the settlement type menu 414 are annotated with an asterisk to indicate to the user 122 that a response to each is required in order to proceed further. It should be appreciated that a page of the interface 400 may include required and not-required response(s) (which may be decided by prior responses). In one example, there may be different options for settlements on the settlement options tab 404 based on the response to the currency menu 412 and/or the type of settlement at menu 414, such that the responses in currency tab 402 are required in order for the rules engine 118 to properly populate the settlement options tab 404.

It should be understood that the tabs shown on form 400 are exemplary. In certain embodiments, the form 400 may have more, fewer, or different tabs available for user selection. And, in alternative embodiments, the form 400 may represent separate parts thereof in different manners, such as, for example, in a sequence of interfaces, etc. Further, the form 400 may include selectable buttons that enable the user 122 to advance to the next section of the form 400 or to go back to the previous section (broadly, interfaces), i.e., navigate within different interfaces of the form 400. Furthermore, responses may be provided in the form 400 via boxes, radio buttons, pulldown menus, or text entry fields, etc.

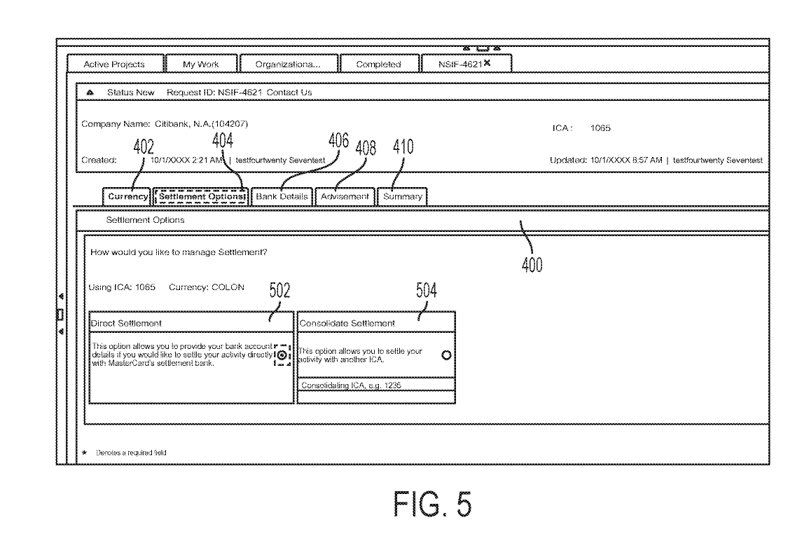

FIG. 5 illustrates the exemplary form 400 with the settlement options tab 404 selected, which offers the user 122 a choice between a direct settlement button 502 and a consolidate settlement button 504. In this exemplary instance, the choice between the two buttons 502 and 504 determines a bank that is used for the settlement, whether that be the payment network 106 with direct settlement (e.g., via the payment network's bank partner, or via the payment network 106 acting as a bank, etc.), or a different bank with a consolidated settlement. The direct settlement button 502 may only be available to a subset of acquirers/issuers (broadly customers), such as “principle” customers. For example, with reference to FIGS. 3 and 5, upon selection of the direct settlement button 502 (which is received by the rules engine 118, at 310), the rules engine 118 may determine a change is needed, at 312, alter the form, at 314, and cause the bank details tab 406 to be activated or selectable (broadly, displayed) in form 400, at 306. Alternatively, upon selection of the consolidate settlement button 504, the form 400 may require the user 122 to provide a valid ICA. In addition, the form 400 may require that the provided ICA already be set up for the selected settlement service with valid bank account information. Then, after selection of a valid ICA, the rules engine 118 may determine a change is needed, at 312, alter the form, at 314, and cause the advisement tab 408 (or another tab) to be activated or selectable (broadly, displayed) in form 400, at 306.

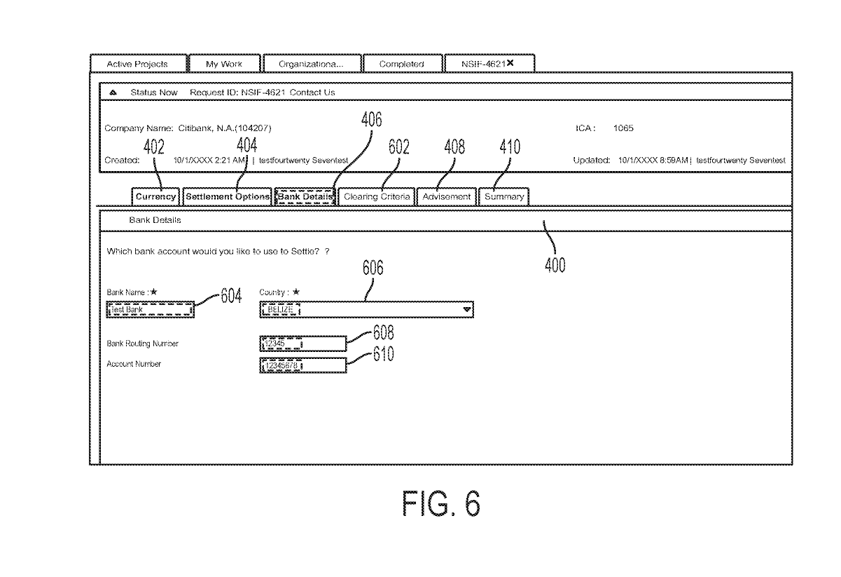

FIG. 6 illustrates the exemplary form 400 with the bank details tab 406 selected. The bank details tab 406 may be activated or selectable, for example, when the user 122 selects direct settlement at the settlement options tab 404. Then, the particular fields requested/collected from the user 122 at the tab 406 will generally depend on business rules defined at the rules engine 118. For example, each bank could have a unique set of “flex fields/bank fields” that are required (which can be managed in the business rules at the bank currency/combination).

As also shown in FIG. 6, an additional tab, i.e., the clearing criteria tab 602, is appended to the form 400 as a selectable tab. For example, with additional reference to the method 300, the rules engine 118 may determine, at 312, based on a response from the user 122, that a change was needed, and then alter the form at 314 to append the additional tab and cause the altered form 400 to be displayed, at 306, to the user 122 at workstation computing device 124. In this example, the clearing criteria tab 602 is added in response to the selected currency and settlement type on the currency tab 402 (and when a regional default is not selected). In some embodiments, particular settlement types and/or currencies may be configured to have clearing criteria, which may cause the clearing criteria tab 602 to be included in the form 400, or not.

With further reference to FIG. 6, the bank details tab 406 includes several user inputs allowing a user to respond with a bank to use for the settlement. The inputs include a bank name field 604, a country field 606, a bank routing number field 608, and an account number field 610. The bank name field 604, the bank routing number field 608, and the account number field 610 are text entry boxes, while the country field 606 is a drop-down menu. Again, it should be understood that the input types shown in the bank details tab 406 are merely exemplary, not limiting, and that other input methods may be used in the form to gather the necessary information.

It should be appreciated that the content of the bank details tab 406 may be different (or altered by the rules engine 118, at 314) based on input provided in prior or other tabs in the form 400, such as, for example, the currency tab 402 and the settlement options tab 404. As described, for example, in some embodiments the bank details tab 406 may only be available if a direct settlement type is selected previously. In particular, for a direct settlement response in the settlement options tab 404, the user 122 may be required to enter bank information into the bank name field 604, the country field 606, and other fields, such as the bank routing number field 608. Field entries, such as the drop-down menu of the country field 606, may be altered, by the rules engine 118 (at 314) with valid data entries based on the business rules and/or the responses from other tabs. Other fields may have rules-based requirements. For example, the bank routing number field 608 may require nine (9) numeric characters for a valid response, etc. The fields may also be defined by business rules, and altered by the rules engine 118, to be required or optional based on the prior responses and/or business rules.

In some embodiments, the rules engine 118 may alter, at 314, the form 400 to include the bank details from a data structure based on the bank and/or ICA selected previously.

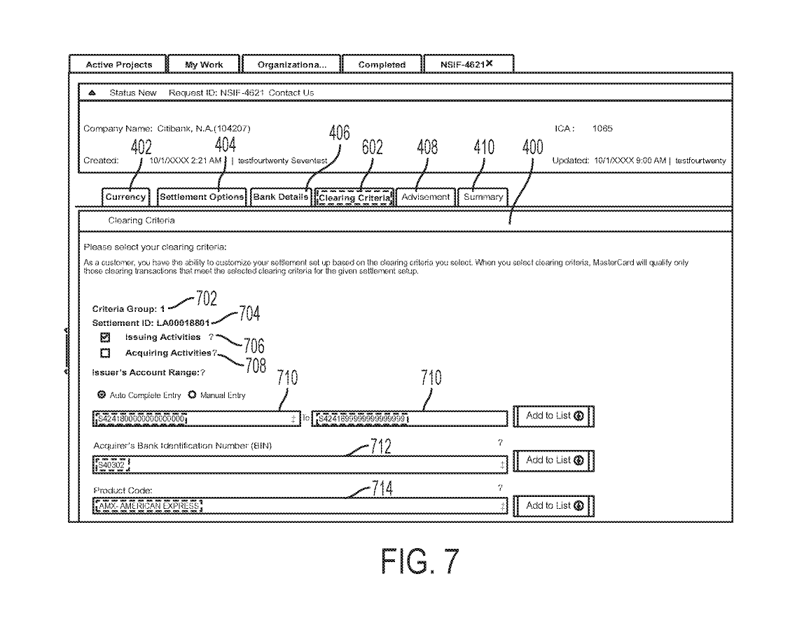

FIG. 7 illustrates the exemplary form 400 with the clearing criteria tab 602 selected. The tab 602 enables the user 122 to set limitations regarding what clearing transactions will qualify for clearing for the settlement setup. An exemplary clearing criteria group display 702 is shown, which includes a settlement ID indicator 704 and selection boxes 706 and 708 for setting whether the defined criteria group “1” applies to issuing activities (via box 706) or acquiring activities (via box 708). In some embodiments, both boxes may be checked to indicate that the criteria group “1” applies to both types of activities. Further, the clearing criteria group display 702 includes entry boxes 710 for setting a range of issuer account numbers to which the clearing criteria applies. The user 122 may also enter a Bank Identification Number (BIN) in box 712 and a product code in box 714. The field entries (e.g., entry boxes 710, 712, and 714, etc.) may be altered, by the rules engine 118, based on business rules and/or responses provided on previous tabs, such as the account range boxes 710 being limited based on the accounts to which the issuer 108b has access. Additionally, again, the rules engine 118 may alter, at 314, the form 400 by populating the field entries with responses available from previous tabs and/or data structures, such as the working data structure 120.

It should be understood that multiple criteria groups (e.g., criteria group “1” in FIG. 7) may be created and/or applied as settlement rules/procedures. In one example, the issuer 108b may set up a criteria group based on a range of account numbers and a transaction currency, which would result in transactions including both of those factors qualifying for the criteria group. Alternatively, the issuer 108b may set up a first criteria group with a defined account range and then a second criteria group with a defined transaction currency. Transactions including either factor would trigger either the first or the second criteria group.

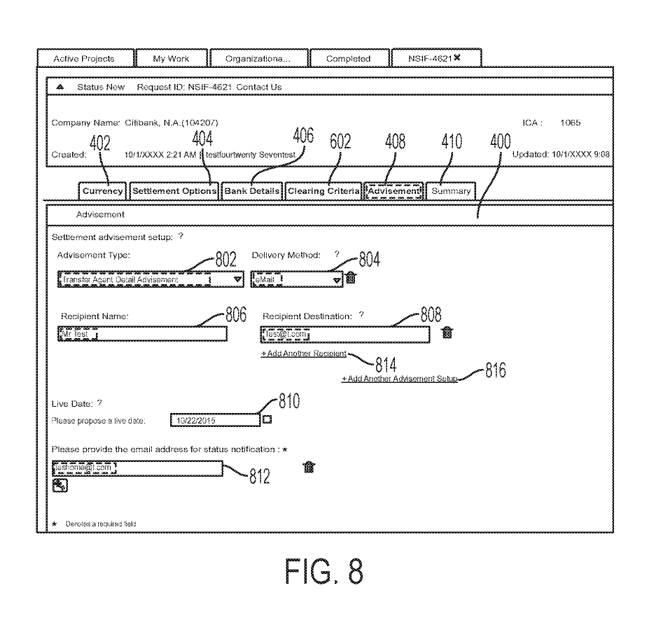

FIG. 8 illustrates the exemplary form 400 with the advisement tab 408 selected. The advisement tab 408 allows the user 122 to select parameters that determine how advisements associated with the settlement occur. For instance, the advisement tab 408 includes an advisement type menu 802 (including options as described below), a delivery method menu 804, a recipient name field 806, a recipient destination field 808, a live date field 810, and an email status notification field 812. By providing responses to one or more of inquiries in tab 408, the user 122 is able to create an advisement, which is sent by the payment network 106 as part of the settlement process. The advisement may be a summary, detailed or otherwise, and may be sent to one or multiple recipients (individually, or in a group) in a variety of manners (e.g., email, short-message-service (SMS), etc.).

In addition in the form 400 illustrated in FIG. 8, the user 122 may add additional recipients for the advisements through use of an add recipient link 814, and may add additional advisements through use of an add advisement setup link 816. It should be understood that the advisement tab 408 may be optional and/or the rules engine 118 may alter the content/options displayed under the tab 408 based on one or more responses provided on other tabs, such as the settlement options tab 404 and/or the bank details tab 406. Further, business rules may be used, by the rules engine 118, to alter the form 400, by limiting the fields/options and/or by populating certain fields of the advisement tab 408 with responses available from previous tabs and/or data structures, such as the working data structure 120. For example, when the user 122 selects, for instance, a particular delivery method from menu 804, the rules engine 118 may alter the form 400 to include different input fields to be completed by the user 122. If “email” is selected, the form 400 may include a recipient destination field 808, under the tab 408, for entering an email address. If instead “fax” is selected as a delivery method, the form 400 may include a different input entry field, which requires entry of a fax number. Further, in another example, a drop-down menu associated with the advisement type menu 802 may be altered to include only valid advisement types for the issuer 108b. In another example, a drop-down menu associated with the recipient field 806 may include only eligible persons approved by the issuer 108b to receive advisements. Further, the rules engine 118, based on prior responses and/or rules, may alter the form 400 to require some responses, while not requiring other responses.

With continued reference to FIG. 8, by selecting link 814 or 816, the exemplary form 400 may further be updated with additional input entries reflecting the link selection. For instance, by selecting to add another recipient, via link 814, the rules engine 118 may alter the form 400, at the tab 408, to include a recipient name text entry and a recipient destination text entry. And, by selecting to add advisement setup, via link 816, the rules engine 118 may alter the form 400 to include additional advisement text entries or other responses.

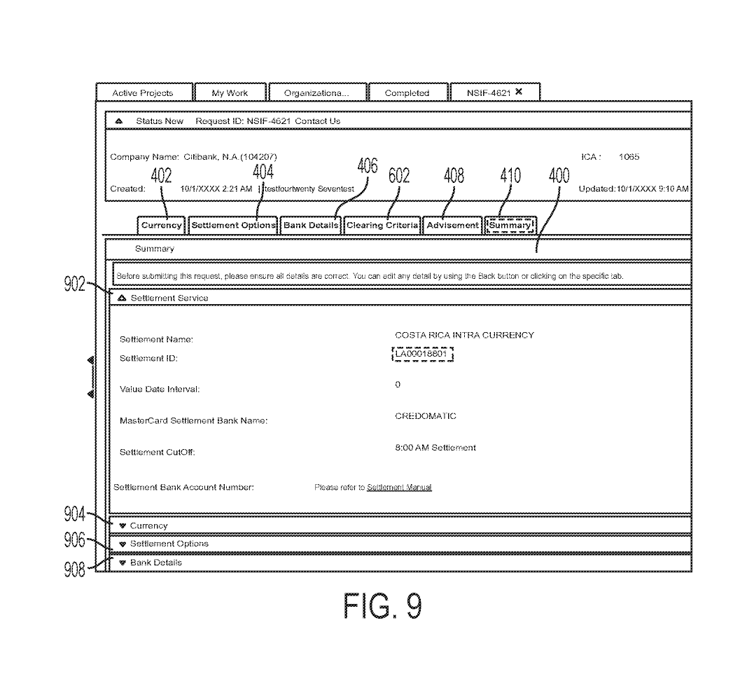

FIG. 9 illustrates the exemplary form 400 with the summary tab 410 selected. The summary tab 410 includes a summary of all of the responses previously defined throughout the prior tabs of the form 400 (included in collapsible sections). A settlement service section 902 is shown, which includes a summary of responses about the settlement service generally, along with collapsed sections, including a currency section 904, a settlement options section 906, and a bank details section 908. When each collapsed section is selected, by the user 122, via the workstation computing device 124, it is expanded to display the summary of response(s) provided, by the user 122, under the respective tab. It should be appreciated that the form 400, and the particular display in FIG. 9, in other embodiments, may include, when the summary tab 410 is selected, a variety of different formats including the same and/or different indicative of the user's responses.

Referring again to FIG. 3, when the rules engine 118 determines, at 312, that no further alterations to the interface (or interfaces) are needed and that the responses (e.g., parameters, etc.) to the interface are complete (in general, or as to the “required” responses), the rules engine 118 confirms the interface is complete, at 316. This may include, for example, transmitting a confirmation to the user 122 to confirm that the responses to the interface are ready to be submitted to the payment network 106, by the user 122, for use in creating the desired settlement rule. In response to the confirmation, the user 122 then submits the responses to the interface, at 318, to the rules engine 118. For example, the user 122 may select an “OK” button or a “Submit” button to cause the user's responses to the interface to be submitted to the rules engine 118. In some embodiments, the user 122 may also have the option, at 318, to make further changes as necessary or desired to the responses to the interfaces prior to submission to the payment network 106.

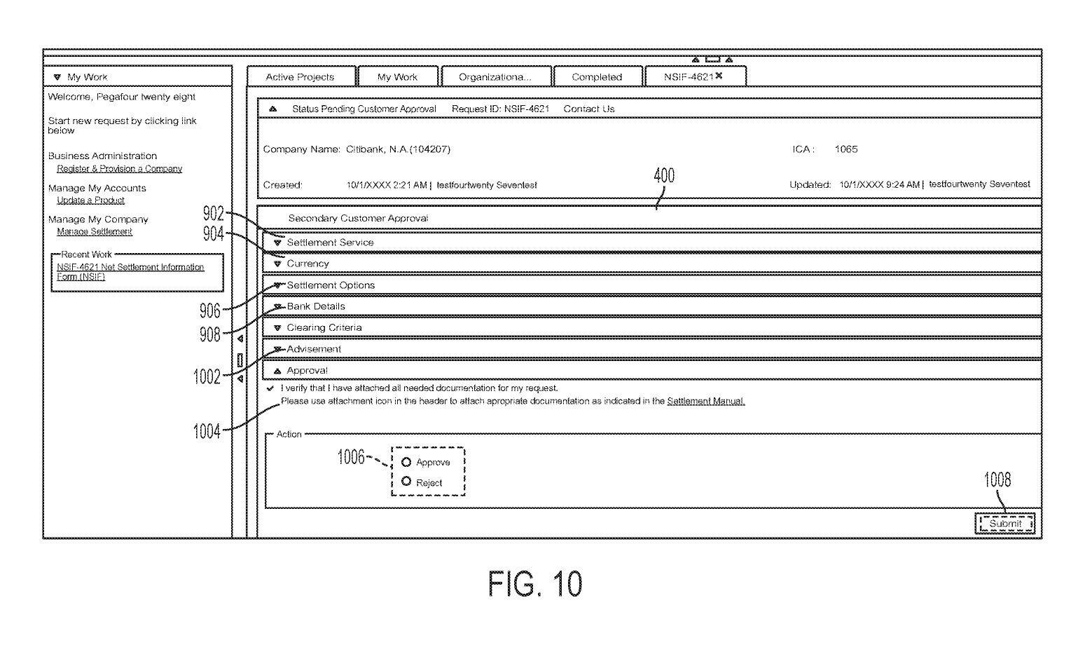

FIG. 10 illustrates the form 400 in condition for approval (e.g., an approval interface associated with the form 400, etc.), or for secondary approval, and includes an approval section 1002. In so doing, the form 400 may be displayed to a second user, similar to the user 122, at a workstation computing device, by the rules engine 118, as a further verification before the rules engine 118 proceeds to create and/or modify the settlement parameters, as indicated by the user's responses. The second user then performs a review of the entire form 400. The second user is separate from the first user 122, such that any data provided in the form 400, for the issuer 102b, is accurate and complete.

As shown in FIG. 10, the approval section 1002 in the form 400 includes a box 1004 for the user to verify the responses are complete and/or sufficient, along with collapsed summaries of the further responses provided by the user 122. Any of the collapsed sections may be selected to review the responses, as indicated by the title on each collapsed section. Further, at this point, the form 400 includes buttons 1006 for the user 122 (or another user) to approve or reject the settlement parameter creation or modification. Finally, a submit button 1008 is provided for selection when completing the form 400. It should be appreciated that final approval and/or rejection of the settlement parameter creation or modification may be based on various business rules associated with the payment network 106, the issuer 108b, etc. In some embodiments, the approval portion of the form 400 is displayed to the second user only after the first user has completed the entire form 400. Here, the rules engine 118 may require that at least two users review and approve the completed form 400 prior to any action being taken based on the form 400.

Referring again back to FIG. 3, at 320, based on the further approval, the rules engine 118 receives the submission and stores the responses to the interfaces in the data structure 120.

At one or more regular or irregular intervals, or at some interval (or immediately) after receiving and/or storing the submission to the data structure 120, the rules engine 118 attempts to load the user's indicated parameters, in the form of settlement rules, to the settlement data structure 112. In particular, the rules engine 118 invokes a settlement data structure API, at 322. The settlement data structure API is a service-based API that enables customers (e.g., the issuer 108b, etc.) with active settlement profiles to retrieve and update their settlement parameters. The rules engine 118 employs the settlement data structure API to save a rule based on the submitted parameters to the working data structure 120, at 324. In turn, the payment network 106 uses the settlement data structure 112 in further settlement operations involving the issuer 108b, as described above. In this exemplary embodiment, the API includes exposed interface calls via a web service (e.g., a representational state transfer (REST) web service) that enables the NSIF and/or other external programs to create new rules with the rules engine 118 and/or review and change rules that have already been created using Hypertext Transfer Protocol (HTTP), or the like. The API may provide data to the NSIF and/or other external programs in the form of Extensible Markup Language (XML) documents, JavaScript Object Notation (JSON) documents, or the like. Use of the API enhances data integrity within the system and reduces risk of data loss, mistakes, and/or other issues stemming from other static form processes.

As should be appreciated, a variety of different interface(s), including various forms, etc., may be employed to solicit responses from one or more users to create and/or modify settlement parameters for acquirers and/or issuers.

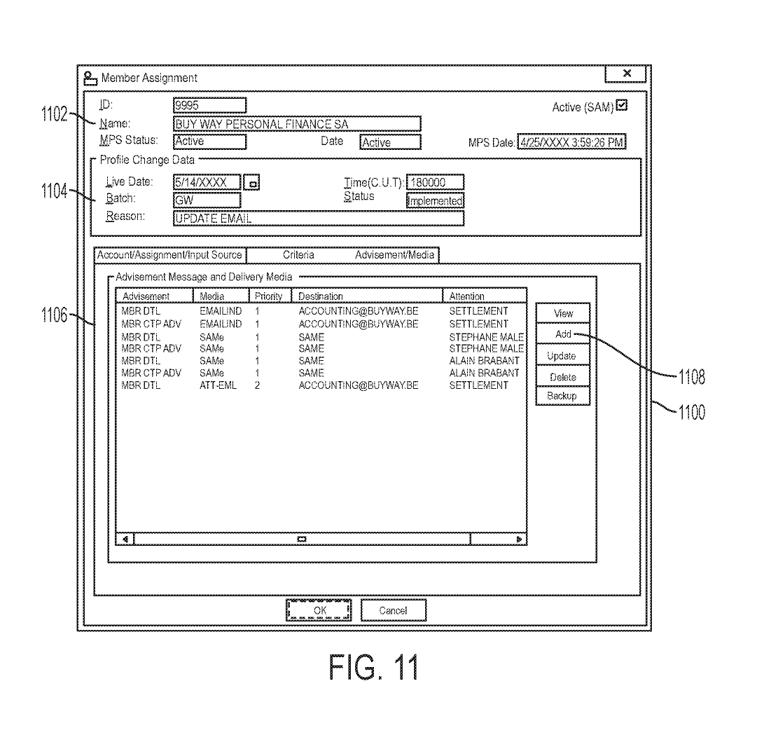

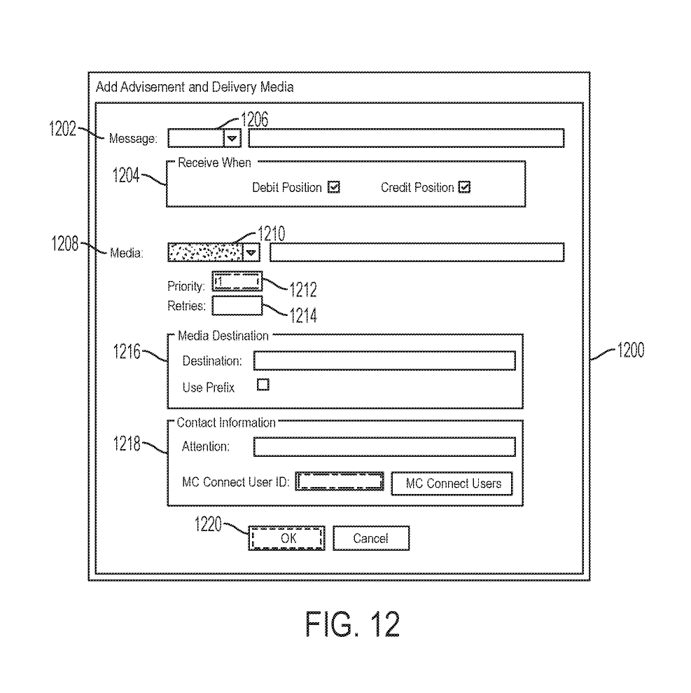

FIGS. 11 and 12 illustrate alternative advisement tabs that may be used in the systems and methods herein. FIG. 11 illustrates an advisement interface 1100, which, for example, consistent with exemplary method 300, may permit the user 122 to view, add, update, etc., the advisements related to settlement, by the issuer 108b. The advisement interface 1100 includes section 1102, which includes an identifier, a name and a MPS status of the issuer 108b. The interface 1100 further includes section 1104, which permits the user 122 to enter, without limitation, parameters including live date and time to implement the change, batch designation which indicates that the changes requested by the user should be grouped, and a reason for the change, etc.

The interface 1100 of FIG. 11 also includes section 1106, which permits the user 122 to select options to view, add, update, delete, or backup advisement parameters for the issuer 108b. Upon selection of one of the options, the rules engine 118 alters the next interface to be displayed based on the selection. For example, when the user 122 selects an “Add” option 1108, the rules engine 118 alters the next interface to include the exemplary interface 1200, as shown in FIG. 12, and causes the same to be displayed to the user 122 at workstation computing device 124.

In turn, interface 1200 includes an advisement type section 1202, which determines the type of the advisement to be delivered, and a “Receive When” section 1204. The message type may include, without limitation Member Detail Advisement (MAD), Member Exception Advisement (MAE), Member Summary Advisement (MAS), member Value Date Advisement (MAV), Member No Activity Notification (MBN), Member Counterparty Advisement (MCA), Member Detail XML Advisement (MDX), Member Future Detail Report (MFD), Transfer Agent Detail Advisement (TAD), Transfer Agent Exception Advisement (TAE), Transfer Agent No Activity Notification (TAN), Transfer Agent Detail Reminder Advisement (TAR), Transfer Agent Summary Advisement (TAS), Transfer Agent Value Date Advisement (TAV), Transfer Agent Counterparty Advisement (TCA), Transfer Agent Detail XML Advisement (TDX), and Transfer Agent Future Detail Report (TFD), etc.

Each of the advisement types is indicative of a particular type of summary, report, notice, etc., related to settlement, which are selectable from a drop down menu 1206 of the interface 1200, from which the advisement type is filled into the adjacent field. For example, when the user 122 selects the “TAD” advisement type, the description “Transfer Agent Detail Advisement” is filled into the adjacent field. The “Receive When” section 1204 includes checkboxes, which, when checked, indicates when the issuer 108b prefers for the recipients to receive the advisement, whether for a debit position and/or for a credit position.

The interface 1200 also includes a media section 1208, which enables the user 122 to determine the media type associated with the currently displayed Advisement/Media relationship. The media type may include email, fax, mail, SMS, voicemail, etc., which, when selected from an associated drop-down menu 1210, is filled into the adjacent field. In one or more embodiments, the available media for selection from the menu 1210 may be altered and/or changed, by the rules engine 118 (at 314, for example), depending on the type of advisement message selected at 1202. In relation to the media section 1208, the interface 1200 includes a priority section 1212. The priority section 1212 enables a user to select a priority level for the current Advisement/Media relationship rule. The priority value may be used to indicate priority, visually, to a receiver of an advisement message associated with the current advisement/media relationship rule (broadly, parameter). Additionally, a higher priority value may indicate that an advisement message has a higher chance of being sent to and seen by an intended receiver of the advisement message. A retries section 1214 is also included, which enables the user 122 to select a number of times to retry sending an advisement message, for example, before halting attempts to send the advisement.

With continued reference to FIG. 12, a media destination section 1216 is further included in the interface 1200. The media destination section 1216 enables the user 122 to specify the destination of an advisement message associated with the current advisement/media relationship rule. In the interface 1200, the media destination section 1216 includes a destination entry field and a “use prefix” entry field. The destination entry field permits the user 122 to enter contact information for the designated recipient, such as an email address, a phone number, a fax number, etc. The available destinations may be dependent on the advisement type and/or media type, such that the rules engine 118 may alter the available and/or acceptable options. The “use prefix” entry field indicates whether the rules engine 118 should use an area code on a local phone number or a country code on an international phone number. The rules engine 118, for example, may alter the interface 1200 to permit selection of the “use prefix” entry field for only certain types of media, or advisement types, according to what is selected above. The interface 1200 further includes a contact information section 1218, which enables the user 122 to enter an attention for inclusion in the message and even select one or more persons to receive the advisement (e.g., by selection from a contacts listing, etc.). Further, the interface of FIG. 12 may include a number of required fields, as indicated by a greyed-out “OK” button 1220. The button 1220, in this exemplary embodiment, is only filled-in and selectable, when the required information in the interface 1200 is supplied.

The interfaces 1100 and 1200 are employed in combination, in various embodiments, to receive responses from the user 122 to create, modify and/or update settlement parameters, etc. The interfaces 1100 and 1200 are consistent with the method 300 and may be used therewith.

Moreover, it should be appreciated that various different interfaces, or inquiries included therein, may be different (as compared to those referred to herein) in other embodiments, while still being used in method 300, or in the system 100, or in different methods and/or systems contemplated herein.

In various embodiments, parameters entered to the interface(s) (as defined by the electronic form) (broadly, responses) are saved, by the rules engine 118, and associated with the issuer 108b, for example. The user-provided parameters may be stored, by the rules engine 118, per field or per page in the same or a different format, or, in some embodiments, only when the user submits a page or navigates between multiple pages, interfaces, or tabs within the interface. In numerous embodiments, therefore, the user 122 is able to enter certain parameters (i.e., responses), exit an interface, and return at a later time to continue and/or complete filling parameters into the interface. In at least one embodiment, parameters entered and/or filled to interfaces are not saved, unless the user 122 specifically submits the interfaces, such as, for example, by selecting a “submit” or “approve” button in the interface.

In view of the above, the systems and methods herein may enable users to create and update settlement rules with the guidance of dynamically generated forms. Users based at acquirers and/or issuers may access the system to create or update one or more settlement parameters through responses to one or more forms (e.g., the NSIF form, etc.). As the user provides responses to the form, the form may be altered to include and/or exclude additional inquiries, prompts or fields from being displayed to the user as necessary. When the user completes the form, the associated settlement parameters is created, modified, or updated. In this manner, users can easily and efficiently create settlement parameters (broadly, rules) for use by and between the payment network and/or the acquirers/issuers to minimize redundant and/or unnecessary responses, and to reduce confusion in creating, modifying, and/or updating settlement parameters.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) receiving a request related to a settlement rule, the request related to creating the settlement rule and/or modifying the settlement rule; (b) causing an interface to be displayed to a user, said interface defining at least part of a settlement form and including a first inquiry related to a first settlement parameter associated with the entity; (c) receiving a first response to the first inquiry from the user; (d) altering one of the interface and/or a subsequent interface of the settlement form to include a second inquiry related to a second settlement parameter associated with the entity, based on the first response; (e) causing the altered one of the interface and/or the subsequent interface to be displayed to the user, whereby one or more subsequent inquiries in the settlement form are consistent with prior responses; and (f) generating and/or altering at least one settlement rule, based on at least the first response, for the entity.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in managing settlement rules, for an entity associated with a payment network and for use by the payment network, the method comprising:
receiving, by a computing device, a request related to a settlement rule, the request related to creating the settlement rule and/or modifying the settlement rule;
causing, by the computing device, an interface to be displayed to a user, said interface defining at least part of a settlement form and including a first inquiry related to a first settlement parameter associated with the entity;
receiving, by the computing device, a first response to the first inquiry from the user;
altering one of the interface and/or a subsequent interface of the settlement form to include a second inquiry related to a second settlement parameter associated with the entity, based on the first response;
causing, by the computing device, the altered one of the interface and/or the subsequent interface to be displayed to the user, whereby one or more subsequent inquiries in the settlement form are consistent with prior responses; and
generating and/or altering at least one settlement rule, based on at least the first response, for the entity.

2. The computer-implemented method of claim 1, wherein the first response identifies an advisement type and/or a media type for an advisement, and a second response to the second inquiry is related to a recipient of the advisement.

3. The computer-implemented method of claim 1, further comprising:
storing the at least one settlement rule in a settlement rule data structure of the payment network; and
settling, by the payment network, multiple transactions involving the entity based on the at least one settlement rule.

4. The computer-implemented method of claim 1, wherein the first response identifies a language and/or a currency to be used in settlement procedures involving the entity.

5. The computer-implemented method of claim 1, wherein generating and/or altering the at least one settlement rule includes:
generating, by the computing device, the at least one settlement rule, based on at least the first response; and
storing the at least one settlement rule in at least one of a working data structure and a settlement rule data structure of the payment network.

6. The computer-implemented method of claim 1, further comprising storing the at least one settlement rule in a settlement rule data structure, via an application programming interface (API) associated with the settlement rule data structure.

7. The computer-implemented method of claim 1, wherein the second inquiry includes a required inquiry; and
wherein the method further comprises receiving, by the computing device, a second response to the second inquiry prior to permitting the settlement form to be submitted.

8. The computer-implemented method of claim 1, wherein altering the one of the interface and/or the subsequent interface includes making only valid responses to the second inquiry available for selection by the user, based on the first response.

9. The computer-implemented method of claim 8, wherein said valid responses are available, for selection, from a drop-down menu within the interface and/or the subsequent interface.

10. The computer-implemented method of claim 1, wherein the interface includes a first tab and a second tab, the first tab including a first part of the settlement form and including at least the first inquiry, the second tab including a second part of the settlement form; and
wherein altering the one of the interface and/or the subsequent interface includes appending a third tab to the interface based on the first response in the first tab, the third tab including a different part of the settlement form.

11. The computer-implemented method of claim 10, wherein the interface further includes a summary tab, the summary tab including a summary of responses to the first, second and third tabs of the interface.

12. A computer-implemented method for use in creating a settlement rule defining advisements to be transmitted, specific to a recipient and at least one of an advisement type and a media type, the method comprising:
causing, by a computing device, at least one interface to be displayed to a user associated with a banking entity, the at least one interface including at least a first inquiry associated with an advisement type and a second inquiry associated with a media type;
receiving, at the computing device, for a first recipient, a first response to the first inquiry;
receiving, at the computing device, for the first recipient, a second response to the second inquiry;
generating, by the computing device, a settlement rule based on at least one of the received first and second responses, the settlement rule associated with the first participant and being consistent with the advisement type of the first response and/or the media type of the second response; and
storing, by the computing device, the settlement rule in a settlement rule data structure, whereby subsequent advisements to the banking entity are subject to the settlement rule.

13. The computer-implemented method of claim 12, further comprising altering the at least one interface in response to the first response and/or the second response; and
causing the altered at least one interface to be displayed to the user.

14. The computer-implemented method of claim 12, wherein the media type of the second response is indicative of at least one of email, fax, SMS, MMS, voicemail, and/or mail.

15. The computer-implemented method of claim 14, wherein the selected advisement type is one of Member Detail Advisement (MAD), Member Exception Advisement (MAE), Member Summary Advisement (MAS), member Value Date Advisement (MAV), Member No Activity Notification (MBN), Member Counterparty Advisement (MCA), Member Detail XML Advisement (MDX), Member Future Detail Report (MFD), Transfer Agent Detail Advisement (TAD), Transfer Agent Exception Advisement (TAE), Transfer Agent No Activity Notification (TAN), Transfer Agent Detail Reminder Advisement (TAR), Transfer Agent Summary Advisement (TAS), Transfer Agent Value Date Advisement (TAV), Transfer Agent Counterparty Advisement (TCA), Transfer Agent Detail XML Advisement (TDX), and Transfer Agent Future Detail Report (TFD).

16. The computer-implemented method of claim 12, wherein storing the settlement rule in the settlement rule data structure includes invoking an application program interface (API) associated with the payment network.

17. The computer-implemented method of claim 12, wherein the first inquiry includes a required status indicator, whereby the response to the first inquiry is required prior to generating said settlement rule.

18. The computer-implemented method of claim 12, further comprising transmitting, by the computing device, an advisement to the first recipient based on the settlement rule.

19. The computer-implemented method of claim 12, further comprising receiving, at the computing device, an indication of a first recipient.

20. The computer-implemented method of claim 12, further comprising:
receiving, at the computing device, an indication of a second recipient;
receiving, at the computing device, for the second participant, a further response to the second inquiry; and
creating, at the computing device, a second settlement rule based on the further response to the second inquiry for the second recipient;
wherein the second settlement rule is associated with the second recipient and is consistent with the media type of the further response.
